(19) United States
(12) Patent Application Publication
(10) Pub. No.: US 2025/0367926 A1
(43) Pub. Date: Dec. 4, 2025

(54) LIQUID EJECTION HEAD

(71) Applicant: CANON KABUSHIKI KAISHA, Tokyo (JP)

(72) Inventors: SHIGEO AOYAGI, Kanagawa (JP); MOTOHIRO OGAWA, Kanagawa (JP); TAKUYA IWANO, Tokyo (JP); YUMI KOMAMIYA, Kanagawa (JP)

(21) Appl. No.: 19/224,204

(22) Filed: May 30, 2025

(30) Foreign Application Priority Data
Jun. 4, 2024 (JP) 2024-090691

(51) Int. Cl. B41J 2/14

(52) U.S. Cl. CPC B41J 2/14129; B41J 2/14072; B41J 2/14145

(57) ABSTRACT

A liquid ejection head includes a flow channel member including a flow channel through which liquid flows and a heating member that is attached to an outer wall surface of the flow channel member and configured to heat the liquid in the flow channel. The heating member includes a first layer including a heat generation portion configured to generate heat by applied power, a second layer including a first conductive portion facing one surface of the heat generation portion, and a first coupling portion that electrically couples the heat generation portion and the first conductive portion.

### BACKGROUND OF THE INVENTION

### Field of the Invention

The present disclosure relates to a liquid ejection head that ejects liquid.

### Description of the Related Art

In an inkjet recording apparatus equipped with a liquid ejection head that ejects liquid, such as ink, in order to maintain recording quality, an amount of liquid per droplet ejected from the liquid ejection head (hereinafter referred to as an amount of a liquid droplet) is required to be constant. In order to make amounts of liquid droplets constant, it is effective to appropriately maintain the viscosity of liquid in the flow channel(s) of the liquid ejection head. In general, the viscosity of liquid is highly temperature-dependent, and thus it is effective to keep the temperature of the liquid within a predetermined temperature range.

Japanese Patent No. 5958365 describes a recording head in which a heater serving as a heating member is attached to an outer wall surface of a manifold serving as a flow channel member. In this recording head, the liquid in the flow channel(s) can be heated by the heater generating heat.

However, there is the following issue with the recording head described in Japanese Patent No. 5958365.

Depending on the composition of a liquid, the temperature suitable for ejecting the liquid may vary. In order to heat a liquid which has a high temperature suitable for ejecting the liquid up to a predetermined temperature within a predetermined period, it is necessary to increase the amount of heat per unit time applied to the liquid by increasing the power supplied to the heater. However, the increased amount of heat of the heater causes the temperature range of a spatial temperature distribution of the heater to increase, making it difficult to effectively heat the liquid in the flow channel(s).

### SUMMARY OF THE INVENTION

The present disclosure is directed to providing a liquid ejection head capable of effectively heating a liquid in a flow channel even with an increased amount of heat (electric power) of a heating member.

According to an aspect of the present disclosure, a liquid ejection head includes a flow channel member including a flow channel through which liquid flows and a heating member that is attached to an outer wall surface of the flow channel member and configured to heat the liquid in the flow channel. The heating member includes a first layer including a heat generation portion configured to generate heat by applied power, a second layer including a first conductive portion facing one surface of the heat generation portion, and a first coupling portion that electrically couples the heat generation portion and the first conductive portion.

Further features of the present disclosure will become apparent from the following description of exemplary embodiments with reference to the attached drawings.

### BRIEF DESCRIPTION OF THE DRAWINGS

FIG. 1 is a perspective view of a liquid ejection head according to a first exemplary embodiment of the present disclosure.

FIG. 2 is an exploded perspective view of the liquid ejection head illustrated in FIG. 1.

FIG. 3 is a schematic view for describing an example of a heating member.

FIG. 4 is a cross-sectional view of the heating member illustrated in FIG. 3.

FIG. 5A is a plan view of a heat generation portion, and FIG. 5B is a plan view of a first conductive portion.

FIG. 6 is a cross-sectional view of a first coupling portion illustrated in FIG. 4.

FIG. 7 is a schematic diagram illustrating paths of electric current through the heating member illustrated in FIG. 3.

FIG. 8 is a schematic diagram illustrating heat conduction path of the heating member illustrated in FIG. 3.

FIG. 9 is a schematic view for illustrating a configuration of a heating member of a comparative example.

FIG. 10 is a cross-sectional view of the heating member illustrated in FIG. 9.

FIG. 11 is a plan view of the heating portion illustrated in FIG. 10.

FIG. 12 is a diagram for describing a one-dimensional model analysis of a heating member.

FIG. 13 is a diagram for describing a temperature distribution in a case where the one-dimensional model analysis illustrated in FIG. 12 is applied to the heating member illustrated in FIG. 9.

FIG. 14 is a diagram for describing a temperature distribution in a case where the one-dimensional model analysis illustrated in FIG. 12 is applied to the heating member illustrated in FIG. 3.

FIG. 15 is a schematic diagram for describing an example of a heating member of a liquid ejection head according to a second exemplary embodiment of the present disclosure.

FIG. 16 is a cross-sectional view of the heating member illustrated in FIG. 15.

FIG. 17 is a schematic diagram illustrating paths of electric current through the heating member illustrated in FIG. 15.

FIG. 18 is a schematic diagram illustrating heat conduction path of the heating member illustrated in FIG. 15.

FIG. 19 is a diagram for describing a temperature distribution in a case where the one-dimensional model analysis illustrated in FIG. 12 is applied to the heating member illustrated in FIG. 15.

FIG. 20 is a schematic view illustrating a first modification of the liquid ejection head according to the second exemplary embodiment of the present disclosure.

FIG. 21 is a schematic view illustrating a second modification of the liquid ejection head according to the second exemplary embodiment of the present disclosure.

FIG. 22A is a cross-sectional view of a first coupling portion and a second coupling portion. FIG. 22B is a cross-sectional view of the first coupling portion and the second coupling portion.

FIG. 23A is a diagram schematically illustrating a relationship between sizes of the heat generation portion and the first conductive portion. FIG. 23B is a pattern diagram for describing the relationship between the sizes of the heat generation portion and the first conductive portion.

FIG. 24 is a schematic view illustrating a first modification of the liquid ejection head according to the first exemplary embodiment of the present disclosure.

FIG. 25 is a cross-sectional view of the heating member illustrated in FIG. 24.

FIG. 26 is a schematic diagram illustrating heat conduction path of the heating member illustrated in FIG. 24.

### DESCRIPTION OF THE EMBODIMENTS

Exemplary embodiments of the present disclosure will now be described in detail with reference to the drawings. However, the exemplary embodiments are merely examples, and the scope of the present disclosure is not limited to the exemplary embodiments.

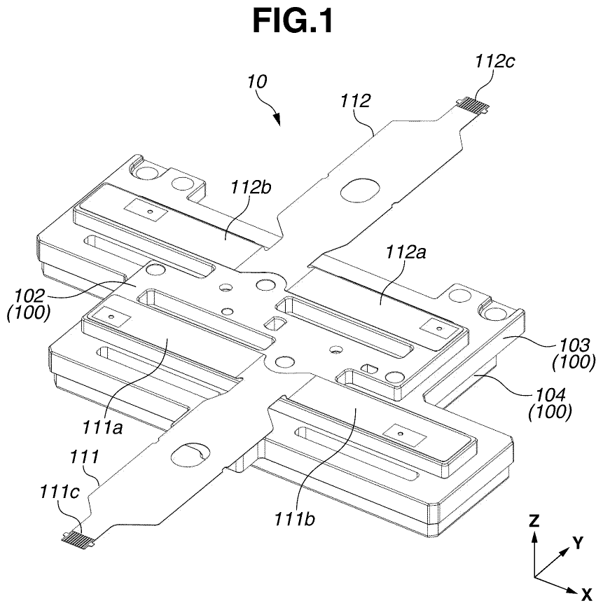

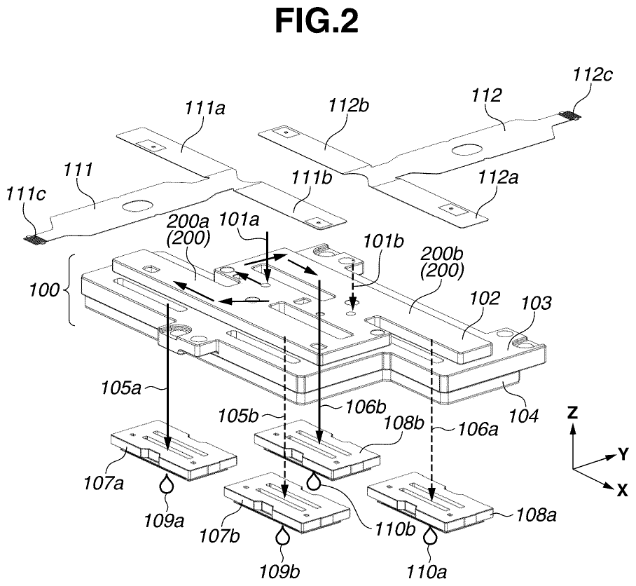

FIG. 1 is a perspective view of a liquid ejection head according to a first exemplary embodiment of the present disclosure. FIG. 2 is an exploded perspective view of the liquid ejection head illustrated in FIG. 1. In FIG. 2, both solid arrows and broken arrows indicate channels through which liquids, such as ink, flow.

Referring to FIGS. 1 and 2, a liquid ejection head 10 includes two heating members 111 and 112, a flow channel member 100 consisting of first to third flow channel members 102 to 104, and four recording chips 107a, 107b, 108a, and 108b.

The first flow channel member 102 is joined to one surface of the second flow channel member 103, and the third flow channel member 104 is joined to the other surface of the second flow channel member 103. With the first to third flow channel members 102 to 104 joined, four flow channels 105a, 105b, 106a, and 106b are formed. The flow channel 105a communicates with the recording chip 107a, and the flow channel 105b communicates with the recording chip 107b. The flow channel 106a communicates with the recording chip 108a, and the flow channel 106b communicates with the recording chip 108b.

Surfaces 200a and 200b of the first flow channel member 102 opposite to the side via which the first flow channel member 102 is joined to the second flow channel member 103 constitute an outer wall surface 200 of the flow channel member 100. The surface 200a is adjacent to the flow channels 105a and 105b and extends in a Y direction. The surface 200b is adjacent to the flow channel 106a and 106b and extends in the Y direction.

Liquids 101a and 101b are supplied to the liquid ejection head 10 from supply channels (not illustrated). The liquid 101a is supplied to the recording chips 107a and 108b via the flow channels 105a and 106b, respectively, and the liquid 101b is supplied to the recording chips 107b and 108a via the flow channels 105b and 106a, respectively. The recording chip 107a ejects a liquid droplet 109a, and the recording chip 107b ejects a liquid droplet 109b. The recording chip 108a ejects a liquid droplet 110a, and the recording chip 108b ejects a liquid droplet 110b.

The heating members 111 and 112 may be composed of, for example, a film heater. The heating member 111 has a T-shape which includes heating portions 111a and 111b extending in an X direction and a terminal 111c for applied power. Power applied to the terminal 111c causes electric current to flow through the heating portions 111a and 111b to generate heat. The heating member 112 also has a T-shape which includes heating portions 112a and 112b extending in the X direction and a terminal 112c for applied power. Power applied to the terminal 112c causes electric current to flow through the heating portions 112a and 112b to generate heat.

The heating member 111 has the heating portions 111a and 111b attached to the surface 200a of the outer wall surface 200, and the heating member 111 can heat the liquids flowing through the flow channels 105a and 105b. Specifically, the first flow channel member 102 is heated by the heating portions 111a and 111b generating heat by applied power, heating the second flow channel member 103, the third flow channel member 104, and the recording chips 107a and 107b through heat conduction. As a result, the liquids flowing through the flow channels 105a and 105b are also heated through the heat conduction.

The heating member 112 has the heating portions 112a and 112b attached to the surface 200b of the outer wall surface 200, and the heating member 112 can heat the liquids flowing through the flow channels 106a and 106b. Specifically, the first flow channel member 102 is heated by the heating portions 112a and 112b generating heat by applied power, heating the second flow channel member 103, the third flow channel member 104, and the recording chips 108a and 108b through heat conduction. As a result, the liquids flowing through the flow channels 106a and 106b are also heated through the heat conduction.

A structure of the heating members 111 and 112 will now be described in detail.

The heating members 111 and 112 have the same structure, the heating members 111 and 112 are referred to as a heating member 113 in the following description, and a configuration of the heating member 113 will be described in detail.

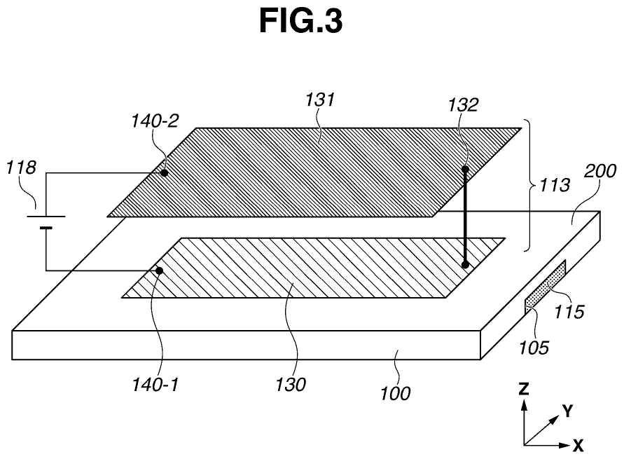

FIG. 3 is a schematic diagram for describing an example of the configuration of the heating member 113. Referring to FIG. 3, the flow channel member 100 includes a flow channel 105, and the heating member 113 is attached to the outer wall surface 200 of the flow channel member 100. The flow channel 105 corresponds to any of the flow channels 105a, 105b, 106a, and 106b illustrated in FIG. 2. A liquid 115 flows through the flow channel 105.

The heating member 113 includes a heat generation portion 130, a first conductive portion 131, and a first coupling portion 132. The heat generation portion 130 corresponds to any of the heating portions 111a and 111b illustrated in FIG. 2, and is composed of, for example, a film heater. The heat generation portion 130 extends in the X direction, and a terminal 140-2 is disposed at one end of the heat generation portion 130 in a longer direction. The terminal 140-2 is connected to the positive terminal of the power supply 118.

The first conductive portion 131 is disposed facing the heat generation portion 130 and extends in the X direction. A terminal 140-1 is disposed at one end of the first conductive portion 131 in a longer direction. The terminal 140-1 is connected to the negative terminal of the power supply 118. These terminals 140-1 and 140-2 are a pair of terminals for applied power.

The first coupling portion 132 electrically couples the heat generation portion 130 and the first conductive portion 131. Here, the other end of the heat generation portion 130 in the longer direction and the other end of the first coupling portion 131 in a longer direction are electrically connected via the first coupling portion 132. For example, copper (Cu) may be used as the material of the first conductive portion 131 and the first coupling portion 132.

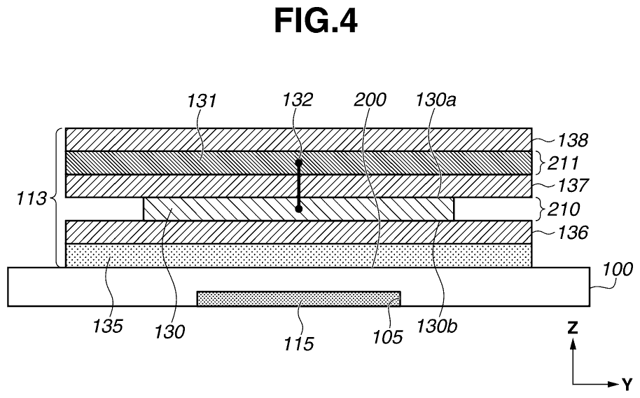

FIG. 4 is a cross-sectional view of the heating member 113 illustrated in FIG. 3. FIG. 4 schematically illustrates a cross-sectional structure of the heating member 113 in a shorter direction (the Y direction).

Referring to FIG. 4, the heating member 113 has a multi-layer structure which includes a first layer 210 including the heat generation portion 130 and a second layer 211 including the first conductive portion 131. The heat generation portion 130 includes a first surface 130a and a second surface 130b opposite to the first surface 130a, and applied power causes heat to generate from both the first surface 130a and the second surface 130b. The second surface 130b of the heat generation portion 130 is fixed to the outer wall surface 200 of the flow channel member 100 via an adhesive member 135 and an insulating member 136. Between the first surface 130a and the second surface 130b, the surface disposed facing the first conductive portion 131 is referred to as one surface.

The first conductive portion 131 faces the first surface (one surface) 130a of the heat generation portion 130. The first conductive portion 131 is sandwiched between insulating members 137 and 138, and the insulating member 137 is fixed to the first surface 130a of the heat generation portion 130. The first conductive portion 131 acts to even out heat generated on the first surface 130a of the heat generation portion 130.

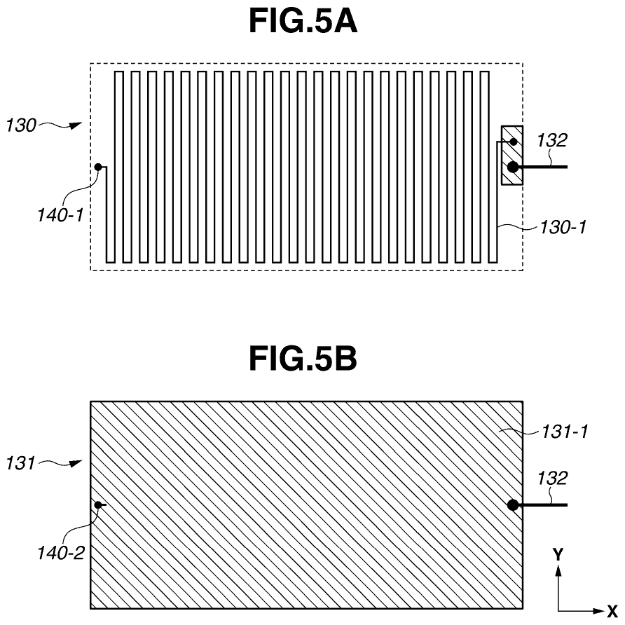

FIGS. 5A and 5B are diagrams schematically illustrating structures of the heat generation portion 130 and the first conductive portion 131 illustrated in FIG. 4. FIG. 5A is a plan view of the heat generation portion 130, and FIG. 5B is a plan view of the first conductive portion 131.

As illustrated in FIG. 5A, the heat generation portion 130 includes a heat generation pattern 130-1. The heat generation pattern 130-1 is formed by a wire being folded back at regular intervals a plurality times to form a planar heat generation portion, and at one end of the wire, a terminal 140-2 is disposed, and the other end of the wire is electrically connected to the first coupling portion 132. For example, CuNi or the like can be used as the material of the wire of the heat generation pattern 130-1. The heat generation pattern 130-1 is not limited to the pattern illustrated in FIG. 5A. The heat generation pattern 130-1 may be formed in any pattern as long as a planar heat generation portion can be formed.

As illustrated in FIG. 5B, the first conductive portion 131 includes a uniform pattern 131-1.

The uniform pattern 131-1 is uniform in shape, and thus is effective in evening out heat generated on the first surface 130a of the heat generation portion 130. A terminal 140-1 is disposed at one of both ends of the uniform pattern 131-1 in the longer direction, and the other end is electrically connected to the first coupling portion 132. The purpose of the uniform pattern 131-1 is to even out heat generated on the heat generation portion 130 and to be a part of a power applying circuit of the heat generation portion 130. For this purpose, copper (Cu), for example, is preferably used as the material of the uniform pattern 131-1. The pattern of the first conductive portion 131 is not limited to the pattern illustrated in FIG. 5B. The first conductive portion 131 may be formed in any pattern as long as the first conductive portion 131 having the pattern can even out heat generated on the heat generation portion 130 and be a part of the power applying circuit.

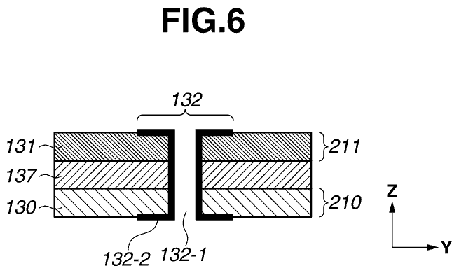

FIG. 6 is a cross-sectional view of the first coupling portion 132 illustrated in FIG. 4. As illustrated in FIG. 6, the first coupling portion 132 has a through hole 132-1 and a thin metal film 132-2 formed over the inner surface of the through hole 132-1. The through hole 132-1 penetrates the first layer 210, the insulating member 137, and the second layer 211. The heat generation portion 130 in the first layer 210 is electrically connected to the first conductive portion 131 in the second layer 211 via the thin metal film 132-2.

A method of forming the first coupling portion 132 illustrated in FIG. 6 will now be described in a simplified manner. First, the heat generation portion 130, the insulating member 137, and the first conductive portion 131 are layered, and the through hole 132-1 is formed in a portion to be a coupling portion. For example, punching with a die or drilling a hole enables forming the through hole 132-1. After the through hole 132-1 is formed, the inner surface of the through hole 132-1 is plated to form the thin metal film 132-2.

Next, paths of electric current flowing through the heating member 113 will be described.

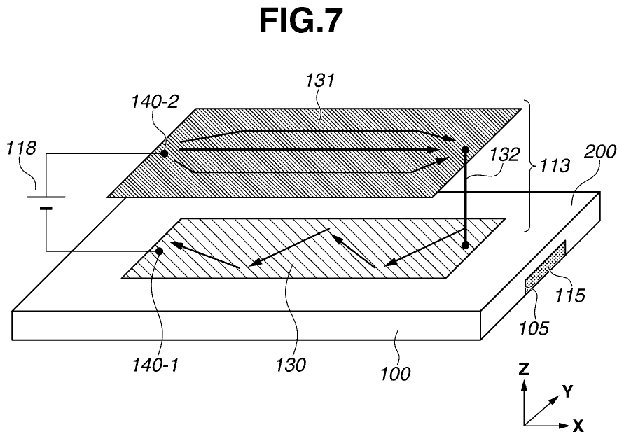

FIG. 7 is a schematic diagram illustrating the paths of electric current through the heating member 113. In FIG. 7, the solid arrows indicate the paths through which electric current flows.

As illustrated in FIG. 7, electric current is supplied from the power supply 118 to the terminal 140-2 of the first conductive portion 131. On the first conductive portion 131, the electric current supplied to the terminal 140-2 flows through the uniform pattern 131-1 illustrated in FIG. 5B toward the first coupling portion 132. Then, the electric current flows from the first coupling portion 132 into the heat generation portion 130. In the heat generation portion 130, the electric current flowing into from the first coupling portion 132 flows through the heat generation pattern 130-1 illustrated in FIG. 5A toward the terminals 140-1. The electric current then returns to the power supply 118 via the terminal 140-1. Thus, the heat generation portion 130, the first conductive portion 131, and the first coupling portion 132 are included in the power applying circuit (a closed circuit for power supply).

Next, heat conduction path of the heating member 113 will be described.

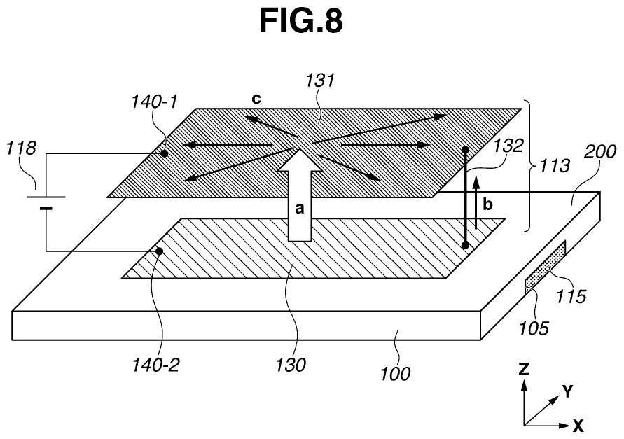

FIG. 8 is a schematic diagram illustrating the heat conduction path of the heating member 113. In FIG. 8, the white arrow a and the solid arrows b and c indicate travel of heat.

Heat generated on the heat generation portion 130 travels to both the flow channel member 100 side (the surface 130b side illustrated in FIG. 4) and the first conductive portion 131 side (the surface 130a side illustrated in FIG. 4). On the first conductive portion 131 side of the heat generation portion 130, the heat travels to the first conductive portion 131 via the insulating member 137 illustrated in FIG. 4 (the white arrow a) and via the first coupling portion 132 (the solid arrow b). Here, the temperature of the surface 130a of the heat generation portion 130 is highest at its center portion, and the white arrow a indicates the heat travel at the center portion. On the first conductive portion 131, the heat from the central portion of the surface 130a diffuses in in-plane directions (the solid arrows c). In this way, the first conductive portion 131 acts to even out the heat generated on the first surface 130a of the heat generation portion 130.

According to the liquid ejection head 10 of the present exemplary embodiment described above, the liquid 115 in the flow channel 105 of the flow channel member 100 is heated using the heating member 113 as illustrated in FIGS. 3 to 8. Even with an increased amount of heat generated on the heat generation portion 130 due to an increased power supplied from the power supply 118, the first conductive portion 131 evens out the heat, allowing the liquid 115 to be effectively heated.

Hereinafter, the above-described effect by the heating member 113 will be specifically described. Here, issues and effects will be described in detail in comparison with a heating member of a comparative example.

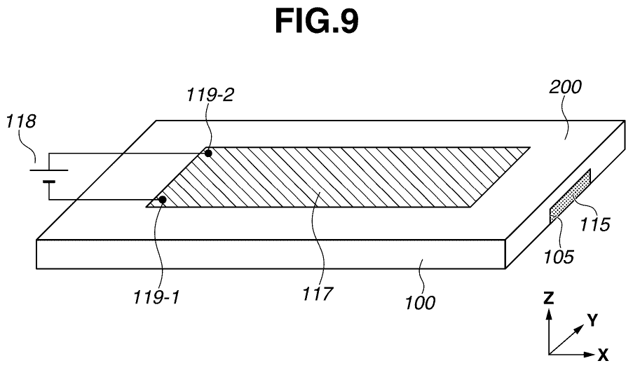

FIG. 9 is a schematic view for describing a configuration of a heating member of a comparative example. As illustrated in FIG. 9, a heating member 117 of the comparative example is attached to the outer wall surface 200 of the flow channel member 100. The flow channel member 100 is the same as that illustrated in FIG. 3. The heating member 117 includes terminals 119-1 and 119-2. The terminal 119-1 is connected to the negative terminal of the power supply 118, and the terminal 119-2 is connected to the positive terminal of the power supply 118.

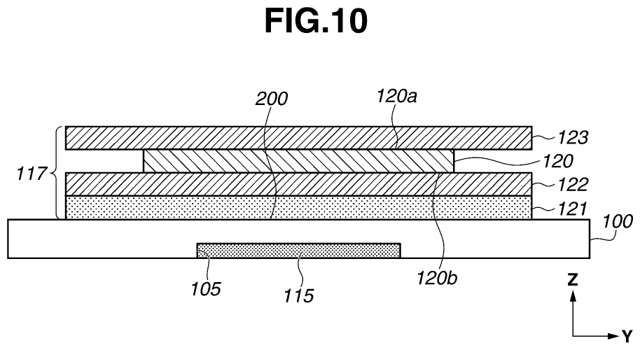

FIG. 10 is a cross-sectional view of the heating member 117 illustrated in FIG. 9. FIG. 10 schematically illustrates a cross-sectional structure of the heating member 117 in the shorter direction (the Y direction).

Referring to FIG. 10, the heating member 117 includes a heat generation portion 120. The heat generation portion 120 includes a first surface 120a and a second surface 120b opposite to the first surface 120a, and the heat generation portion 120 generates heat from both the first surface 120a and the second surface 130b by applied power. The heat generation portion 120 is sandwiched between insulating members 122 and 123. The second surface 120b of the heat generation portion 120 is fixed to the outer wall surface 200 of the flow channel member 100 via an adhesive member 121 and the insulating member 122.

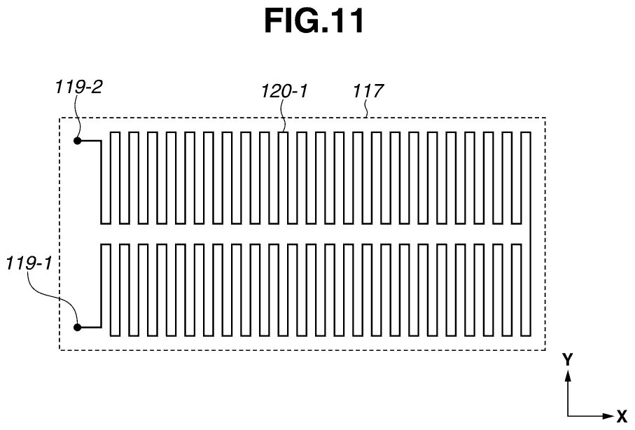

FIG. 11 is a plan view of the heat generation portion 120 illustrated in FIG. 10. As illustrated in FIG. 11, the heat generation portion 120 includes a heat generation pattern 120-1. The heat generation pattern 120-1 is formed by a wire being folded back at regular intervals a plurality of times to form a planar heat generation portion, and at one end of the wire, a terminal 119-1 is disposed, and at the other end of the wire, a terminal 119-2 is disposed. For example, CuNi or the like can be used as the material of the wire of the heat generation pattern 120-1.

Electric current is supplied from the power supply 118 to the terminal 119-2 of the heat generation portion 120. In the heat generation portion 120, the electric current supplied to the terminal 119-2 flows through the heat generation pattern 120-1 illustrated in FIG. 11 to the terminal 119-1. The electric current then returns to the power supply 118 via the terminal 119-1.

As described above, the heat generation portion 120 is included in a power applying circuit (a closed circuit for power supply), and heat is generated by electric current flowing through the heat generation pattern 120-1.

The heating member 117 illustrated in FIG. 9 will now be modeled to consider a spatial temperature distribution. It herein is assumed that the temperature distributions in a thickness direction (the Z direction) and a depth direction (the Y direction) of the heating member 117 are uniform, and the temperature distribution only in a longer direction (the X direction) is subject to the consideration.

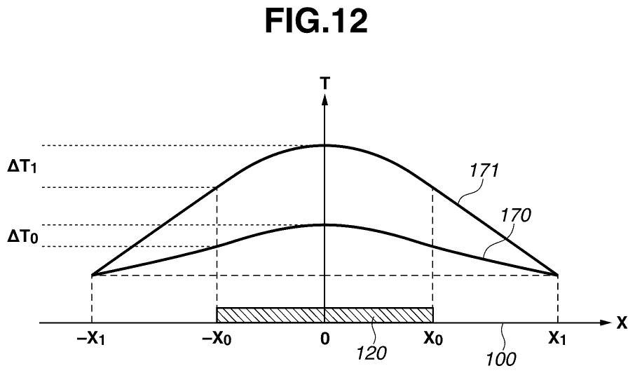

FIG. 12 is a diagram for describing a one-dimensional model analysis of the heating member 117. FIG. 12 illustrates a temperature distribution where the horizontal axis represents the longer direction of the heat generation portion 120 and the vertical axis represents the temperature. On the horizontal axis, the center position of the heat generation portion 120 in the longer direction is set at 0 (zero), and the heat generation portion 120 and the flow channel member 100 are arranged symmetrically with respect to the position of the center position (0). That is, the heat generation portion 120 is disposed in the range from −x₀ to x₀, and the flow channel member 100 that guides heat therefrom is disposed in the ranges from −x₁ to −x₀ and from x₀ to x₁. The ±x₁ portions which are end portions of the flow channel member 100 are given a boundary temperature. Here, the boundary temperature can be used as a boundary condition of a partial differential equation in the one-dimensional model analysis.

A temperature distribution of the heat generation portion 120 and the flow channel member 100 is obtained from the heat equation under the above conditions, as a temperature distribution 170 illustrated in FIG. 12. The temperature distribution 170 has an upwardly convex shape in which the temperature at the position of zero is highest. The temperature increases linearly in the range from −x₁ to −x₀ (the flow channel member 100), and the temperature decreases linearly in the range from x₀ to x₁ (the flow channel member 100).

With an increased heat amount of the heat generation portion 120, the temperature distribution of the heat generation portion 120 and the flow channel member 100 is obtained from the heat conduction equation under the same conditions, as a temperature distribution 171 illustrated in FIG. 12.

The temperature distribution 171 has increased temperatures as a whole while the temperature at the boundaries at the ±x₁ portions remains fixed, as compared with the temperature distribution 170.

The temperature range of the heat generation portion 120 is defined as the difference between a highest temperature and a lowest temperature within the plane of a heater surface (the surface 120a or the surface 120b illustrated in FIG. 10). The temperature range of the heat generation portion 120 in the temperature distribution 170 is ΔT₀. The temperature range of the heat generation portion 120 in the temperature distribution 171 is ΔT₁. Since ΔT₀<ΔT₁, as the amount of heat of the heat generation portion 120 is increased, the temperature range of the heat generation portion 120 is increased.

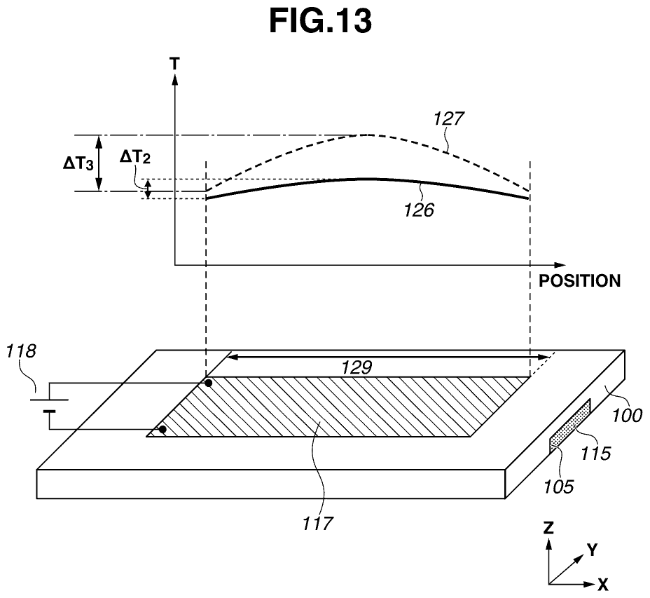

FIG. 13 is a diagram for describing a temperature distribution when the one-dimensional model analysis illustrated in FIG. 12 is applied to the heating member 117 illustrated in FIG. 9. FIG. 13 illustrates the temperature distribution in the upper part with the horizontal axis representing the longer direction (the X direction) of the heating member 117 and the vertical axis representing the temperature.

From the perspective of effectively heating the liquid 115 in the flow channel 105, it is desirable that the temperature of the heating member 117 be uniform over the entire heater surface (here, an entire range 129 in the longer direction). A temperature distribution 126 is used for comparison, corresponding to the temperature distribution 170 illustrated in FIG. 12. In the temperature distribution 126, the temperature range (the difference between a highest temperature and a lowest temperature) of the heating member 117 is ΔT₂. In order to effectively heat the liquid 115, it is preferable to make the temperature range ΔT₂ as small as possible.

With a liquid having a high temperature suitable for ejection used as the liquid 115, it is necessary to increase the amount of heat (supplied power) of the heating member 117. A temperature distribution 127 is an example of a temperature distribution with an increased amount of heat (supplied power) of the heating member 117, corresponding to the distribution 171 illustrated in FIG. 12. In the temperature distribution 127, the temperature range of the heating member 117 is ΔT₃(>ΔT₂). As apparent from the consideration of the one-dimensional model analysis illustrated in FIG. 12, as the amount of heat (supplied power) of the heating member 117 is increased, the temperature of the entire heater surface is increased, and the temperature range ΔT₃ of the heating member 117 is increased. It thus becomes difficult to effectively heat the liquid 115, making it difficult to keep the viscosity of the liquid 115 appropriate.

On the other hand, in the liquid ejection head 10 of the present exemplary embodiment, the temperature range of the heating member 113 can be made smaller than the temperature range of the heating member 117 of the comparative example.

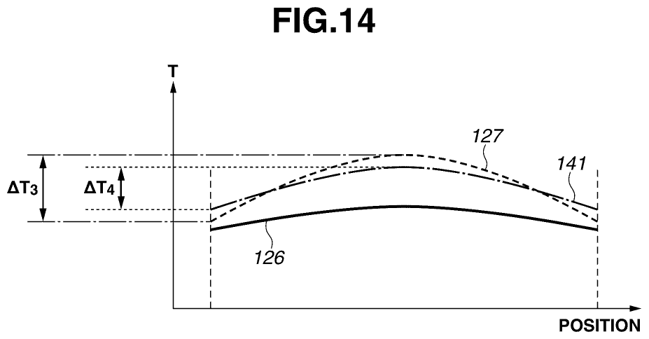

FIG. 14 is a diagram for describing a temperature distribution when the one-dimensional model analysis illustrated in FIG. 12 is applied to the heating member 113. FIG. 14 illustrates the temperature distribution with the horizontal axis representing the longer direction (the X direction) of the heating member 113 and the vertical axis representing the temperature. The temperature distributions 126 and 127 are the same as those illustrated in FIG. 13.

A temperature distribution 141 is an example of a temperature distribution with an increased amount of heat (supplied power) of the heating member 113, similarly to the temperature distribution 127 illustrated in FIG. 13. In the temperature distribution 141, the temperature range of the heating member 113 is ΔT₄ (<ΔT₃). Even as the amount of heat of the heating member 113 is increased, the first conductive portion 131 evens out heat, allowing the temperature range ΔT₄ to be smaller than the temperature range ΔT₃ of the heating member 117 of the comparative example. As a result, the liquid 115 can be effectively heated, and the viscosity of the liquid 115 can be appropriately maintained.

In addition to the above effects, the liquid ejection head 10 of the present exemplary embodiment has the following effects.

As a method of controlling the temperature of the heating member 117 of the comparative example illustrated in FIG. 13, there is a method of performing temperature control using a highest temperature of the temperature distribution 127 as a reference. In this method, the use region of the heater surface of the heating member 117 is limited to a temperature range smaller than the temperature range ΔT₃ (that is, limited to the vicinity of the central portion of the heater surface). Such a limitation of the use region hinders, for example, effective heating of the liquid 115, which is not efficient.

According to the liquid ejection head 10 of the present exemplary embodiment, the temperature range ΔT₄ of the heating member 113 is smaller than the temperature range ΔT₃ of the heating member 117. The above-described temperature control method allows the limitation on the use region of the heater surface to be alleviated and the liquid 115 to be effectively and efficiently heated.

As another method of controlling the temperature of the heating member 117 of the comparative example illustrated in FIG. 13, it is also conceivable to perform temperature control so that an average temperature in the entire temperature distribution 127 (for example, an average temperature between a highest temperature and a lowest temperature) is a predetermined temperature. Specifically, the temperature distribution 127 is measured to calculate the average temperature. If the calculated value is lower than a predetermined temperature, the power to the heating member 117 is increased, and if the calculated value is higher than the predetermined temperature, the power supply to the heating member 117 is stopped. In this method, a portion (central portion) having a locally high temperature is generated on the heater surface, making it difficult to keep the viscosity of the recording liquid 115 appropriate, and changing the characteristics of the recording liquid 115.

According to the liquid ejection head 10 of the present exemplary embodiment, since the temperature range ΔT₄ is smaller than the temperature range ΔT₃, it is possible to mitigate the occurrence of a portion (central portion) where the temperature is locally high on the heater surface using the temperature control method described above. Thus, the liquid ejection head 10 can keep the viscosity of the recording liquid 115 appropriate and reduce the change in the characteristics of the recording liquid 115.

Also, on the heating member 117 of the comparative example illustrated in FIG. 13, the temperature range ΔT₃ can be reduced by evening out heat using, for example, a radiator plate or a heat pipe. However, with a new component, such as a heat sink or a heat pipe, added, the liquid ejection head would be increased in size.

In contrast, in the liquid ejection head 10 of the present exemplary embodiment, the heating member 113 has a multilayer structure in which the second layer 211 including the first conductive portion 131 is added to the first layer 210 including the heat generation portion 130. According to the multilayer structure, it is possible to reduce the increase in the size of the liquid ejection head 10. In addition, the heat generation portion 130, the first conductive portion 131, and the first coupling portion 132 are included in the power applying circuit. Thus, in the multilayer structure, the potential of the added second layer 211 (the first conductive portion 131) can be stabilized.

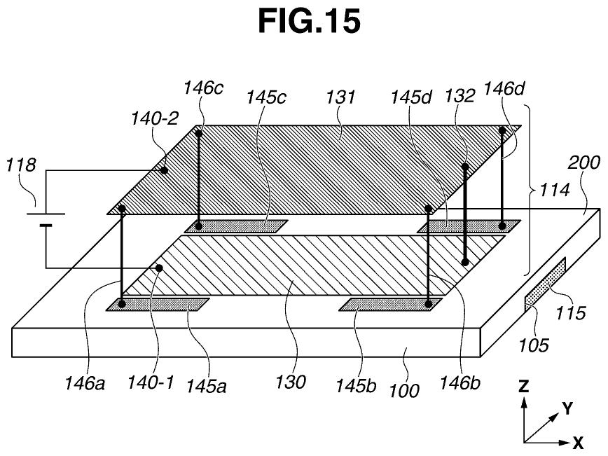

FIG. 15 is a schematic view for describing a configuration of a heating member used in a liquid ejection head according to a second exemplary embodiment of the present disclosure.

Referring to FIG. 15, a heating member 114 is attached to the outer wall surface 200 of the flow channel member 100 including the flow channel 105. The heating member 114 includes the heat generation portion 130, the first conductive portion 131, the first coupling portion 132, second conductive portions 145a to 145d, and second coupling portions 146a to 146d. The flow channel member 100, the heat generation portion 130, the first conductive portion 131, and the first coupling portion 132 are the same as those illustrated in FIG. 3. While one second coupling portion 146a is arranged for the second conductive portion 145a, the exemplary embodiment of the present disclosure is not limited to this configuration. A plurality of second coupling portions 146a may be arranged for the second conductive portion 145a. The same applies to the numbers of the second coupling portions 146b to 146d.

The second conductive portions 145a to 145d are disposed along both edge portions of the heat generation portion 130 in the shorter direction (the Y direction). The second conductive portions 145a and 145b are disposed near both ends of one edge portion, and the second conductive portions 145c and 145d are disposed near both ends of the other edge portion. The second coupling portion 146a electrically couples the second conductive portion 145a and the first conductive portion 131.

The second coupling portion 146b electrically couples the second conductive portion 145b and the first conductive portion 131. The second coupling portion 146c electrically couples the second conductive portion 145c and the first conductive portion 131. The second coupling portion 146d electrically couples the second conductive portion 145d and the first conductive portion 131. For example, copper (Cu) can be used as the material of the second conductive portions 145a to 145d and the second coupling portions 146a to 146d.

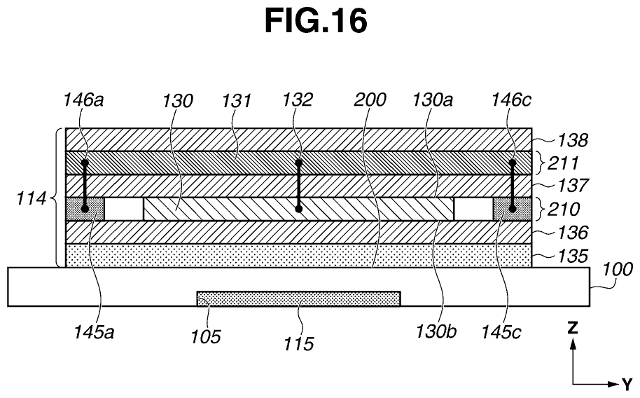

FIG. 16 is a cross-sectional view of the heating member 114 illustrated in FIG. 15. FIG. 16 schematically illustrates a cross-sectional structure of the heating member 114 in the shorter direction (the Y direction).

Referring to FIG. 16, the heating member 114 has a multilayer structure which includes a first layer 210 including the heat generation portion 130 and the second conductive portions 145a to 145d, and a second layer 211 including the first conductive portion 131.

The second conductive portions 145a to 145d all face the first conductive portion 131. The first conductive portion 131 is disposed over the entire heat generation portion 130 and the entire second conductive portions 145a to 145d. The insulating member 137 is arranged between the first layer 210 and the second layer 211. In the first layer 210, the second conductive portions 145a to 145d are adjacent to the heat generation portion 130 and are electrically insulated from the heat generation portion 130, but the second conductive portions 145a to 145d are electrically coupled to the first conductive portion 131 via the second coupling portions 146a to 146d. The first conductive portion 131 and the second conductive portions 145a to 145d act to even out heat generated on the first surface 130a of the heat generation portion 130.

Next, paths of electric current flowing through the heating member 114 will be described.

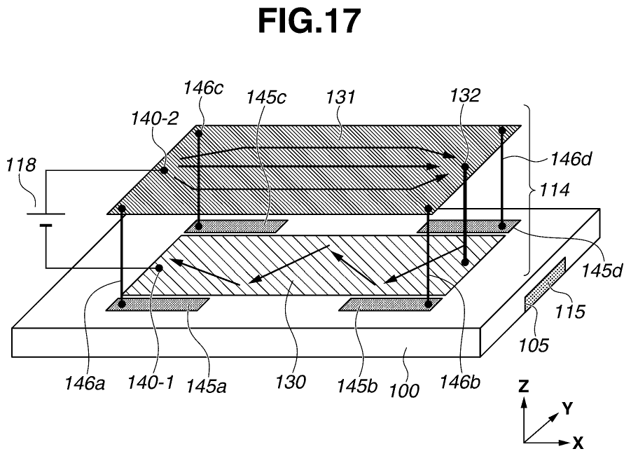

FIG. 17 is a schematic diagram illustrating the paths of electric current flowing through the heating member 114. In FIG. 17, solid arrows indicate the paths through which electric current flows. The paths of electric current of the heating member 114 are the same as those of electric current of the heating member 114 illustrated in FIG. 7. The electric current supplied from the power supply 118 to the terminal 140-2 passes through the first conductive portion 131, the first coupling portion 132, and the heat generation portion 130 in that order, and returns to the power supply 118 via the terminal 140-1. In the present exemplary embodiment, the heat generation portion 130, the first conductive portion 131, and the first coupling portion 132 are included in a power applying circuit (a closed circuit for power supply).

Next, heat conduction path of the heating member 114 will be described.

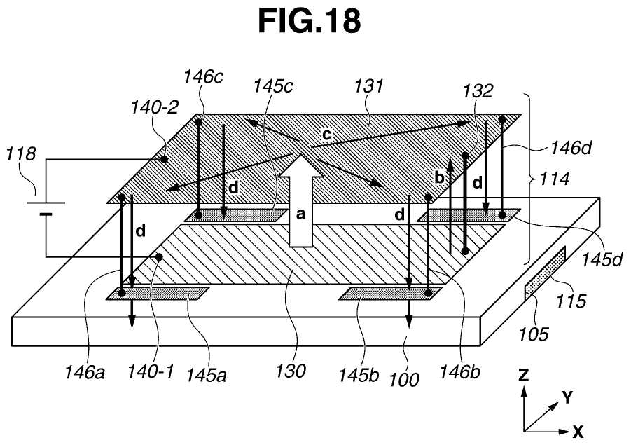

FIG. 18 is a schematic diagram illustrating the heat conduction path of the heating member 114. In FIG. 18, the white arrow a and the solid arrows b, c, and d indicate travel of heat.

Heat generated by the heat generation portion 130 travels to both the flow channel member 100 side and the first conductive portion 131 side. On the first conductive portion 131 side of the heat generation portion 130, the heat travels to the first conductive portion 131 via the insulating member 137 illustrated in FIG. 16 (the white arrow a) and via the first coupling portion 132 (the solid arrow b). Here, the temperature of the heat generation portion 130 is highest at its center portion, and the white arrow a indicates the heat travel at the center portion. On the first conductive portion 131, the heat from the central portion of the surface 130a diffuses in in-plane directions (the solid arrows c). The heat travel indicated by the arrows a to c are the same as those illustrated in FIG. 8.

In the first conductive portion 131, the heat that has diffused in the in-plane directions travels via the second coupling portions 146a to 146d to the second conductive portions 145a to 145d (the solid arrows d). As described above, in the present exemplary embodiment, the second conductive portions 145a to 145d act to even out heat generated on the first surface 130a of the heat generation portion 130, together with the first conductive portion 131.

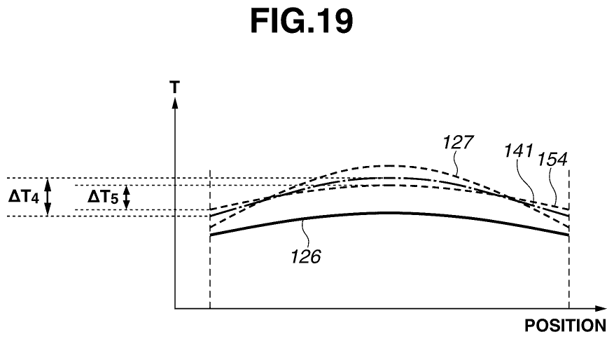

FIG. 19 is a diagram for describing a temperature distribution when the one-dimensional model analysis illustrated in FIG. 12 is applied to the heating member 114. FIG. 19 illustrates the temperature distribution with the horizontal axis representing the longer direction (the X direction) of the heating member 114 and the vertical axis representing the temperature. The temperature distributions 126, 127, and 141 are the same as those illustrated in FIG. 14.

A temperature distribution 154 is an example of a temperature distribution with an increased amount of heat (supplied power) of the heating member 114, similarly to the temperature distribution 141 illustrated in FIG. 14. In the temperature distribution 154, the temperature range of the heating member 114 is ΔT₅ (<ΔT₄). The second conductive portions 145a to 145d in addition to the first conductive portion 131 even out the heat, allowing the temperature range ΔT₅ to be smaller than the temperature range ΔT₄ of the heating member 113 in the first exemplary embodiment. As a result, compared with the first exemplary embodiment, it is possible to more effectively heat the liquid 115, making it possible to keep the viscosity of the liquid 115 more appropriate.

The liquid ejection head of the present exemplary embodiment can also achieve the effects described about the liquid ejection head of the first exemplary embodiment.

The configurations of the liquid ejection heads of the first and second exemplary embodiments described above are examples, and various modifications can be made as necessary. Variations in details will be described.

### Positions of Terminals Connected to Power Supply

Of the pair of terminals 140-1 and 140-2 for connecting the power supply 118, the terminal 140-1 is disposed on the first conductive portion 131 in the second layer 211, and the terminal 140-2 is disposed on the heat generation portion 130 in the first layer 210, but the present exemplary embodiment of the present disclosure is not limited to this configuration. The pair of terminals 140-1 and 140-2 may be disposed in either the first layer 210 or the second layer 211.

For example, in the typical process of forming/connecting the terminals 140-1 and 140-2, the metal portions of the first conductive portion 131 and the heat generation portion 130 are exposed, and the exposed portions are connected to the electric wires of the power supply 118 by soldering, welding, or the like. However, the process of exposing the metal portions is carried out on the individual layers, i.e., the first layer 210 including the heat generation portion 130 and the second layer 211 including the first conductive portion 131, increasing the number of operations, which may reduce reliability. If the terminals 140-1 and 140-2 are formed in either the first layer 210 or the second layer 211, the number of operations can be reduced, enhancing the reliability.

A modification will be described in which the pair of terminals 140-1 and 140-2 is disposed in the first layer 210. In the liquid ejection head of the first or second exemplary embodiment, the heat generation portion 130 is composed of a first divided heat generation portion and a second divided heat generation portion which are electrically insulated from each other. The first coupling portion 132 is composed of a first division coupling part and a second division coupling part. The first division coupling portion electrically couples the first divided heat generation portion and the first conductive portion 131. The second division coupling portion electrically couples the second divided heat generation portion and the first conductive portion 131. One of the pair of terminals 140-1 and 140-2 is disposed on the first divided heat generation portion, and the other is disposed on the second divided heat generation portion.

A modification in which the pair of terminals 140-1 and 140-2 is disposed in the second layer 211 will be described. In the liquid ejection head of the first or second exemplary embodiment, the first conductive portion 131 is composed of a first divided conductive portion and a second divided conductive portion which are electrically insulated from each other. The first coupling portion 132 is composed of the first division coupling portion and the second division coupling portion. The first division coupling portion electrically couples the first divided conductive portion and the heat generation portion 130. The second division coupling portion electrically couples the second divided conductive portion and the heat generation portion 130. One of the pair of terminals 140-1 and 140-2 is disposed on the first divided conductive portion, and the other is disposed on the second divided conductive portion.

Hereinafter, a more specific configuration of the modification in which the pair of terminals 140-1 and 140-2 is disposed in the second layer 211 will be described.

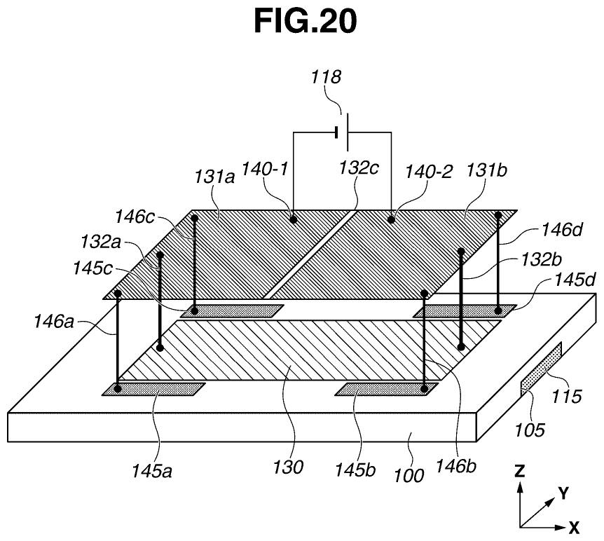

FIG. 20 is a schematic view illustrating a first modification of the liquid ejection head of the second exemplary embodiment. In the first modification, in the heating member 114 illustrated in FIG. 15, the first conductive portion 131 is composed of a first divided conductive portion 131a, a second divided conductive portion 131b, and an insulating portion 132c. The first coupling portion 132 is composed of a first division coupling portion 132a and a second division coupling portion 132b. The first divided conductive portion 131a and the second divided conductive portion 131b are electrically insulated by the insulating portion 132c. The terminal 140-1 is disposed on the first divided conductive portion 131a, and the terminal 140-2 is disposed on the second divided conductive portion 131b.

The first division coupling portion 132a electrically couples the first divided conductive portion 131a and the heat generation portion 130. The second division coupling portion 132b electrically couples the second divided conductive portion 131b and the heat generation portion 130. The second coupling portion 146a electrically couples the second conductive portion 145a and the first divided conductive portion 131a. The second coupling portion 146b electrically couples the second conductive portion 145b and the second divided conductive portion 131b. The second coupling portion 146c electrically couples the second conductive portion 145c and the first divided conductive portion 131a. The second coupling portion 146d electrically couples the second conductive portion 145d and the second divided conductive portion 131b.

### Material of Second Conductive Portion

In the liquid ejection head of the second exemplary embodiment, the first layer 210 includes the heat generation portion 130 and the second conductive portions 145a to 145d. Forming the heat generation portion 130 and the second conductive portions 145a to 145d using the same material makes it easy to facilitate the manufacture of the head, enhancing the reliability.

### Shape of Second Conductive Portion

In the liquid ejection head of the second exemplary embodiment, the second conductive portions 145a to 145d are disposed at the four corners of the heat generation portion 130, but the present exemplary embodiment of the present disclosure is not limited to this configuration. The second conductive portions may be disposed partially or entirely along the peripheral edge portion of the heat generation portion 130.

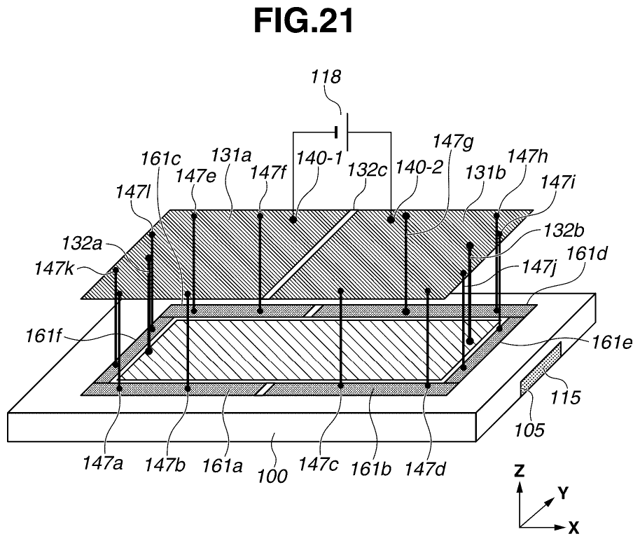

FIG. 21 is a schematic view illustrating a second modification of the liquid ejection head of the second exemplary embodiment. In the second modification example illustrated in FIG. 20, second conductive portions 161a to 161f and second coupling portions 147a to 147l are used instead of the second conductive portions 145a to 145d and the second coupling portions 146a to 146d in the heating member 114 illustrated in FIG. 20.

The second conductive portions 161a to 161f are arranged surrounding the peripheral edge portion of the heat generation portion 130. The second coupling portions 147a and 147d electrically couple the second conductive portion 161a and the first divided conductive portion 131a. The second coupling portions 147c and 147d electrically couple the second conductive portion 161b and the second divided conductive portion 131b. The second coupling portions 147e and 147f electrically couple the second conductive portion 161c and the first divided conductive portion 131a. The second coupling portions 147g and 147h electrically couple the second conductive portion 161d and the second divided conductive portion 131b. The second coupling portions 147i and 147j electrically couple the second conductive portion 161e and the second divided conductive portion 131b. The second coupling portions 147k and 147l electrically couple the second conductive portion 161f and the first divided conductive portion 131a.

According to the second modification example described above, the temperature range ΔT₅ of the heating member 114 can be further reduced, so that the liquid 115 can be more effectively heated, and the viscosity of the liquid 115 can be more appropriately maintained.

If it is difficult to dispose the second conductive portions entirely along the peripheral edge of the heat generation portion 130 for some reason of head manufacture, the second conductive portions may be disposed only in the longer direction or in the shorter direction of the heat generation portion 130.

### Size (Area) of Inner Diameter of First and Second Coupling Portions

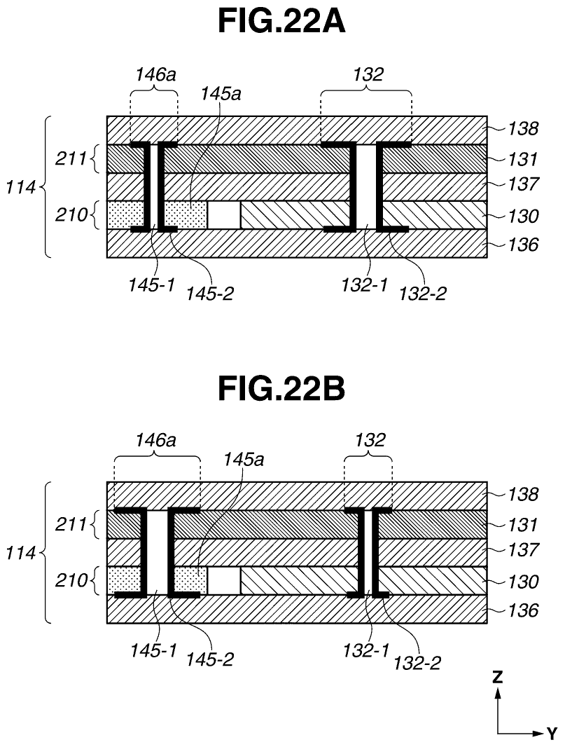

FIGS. 22A and 22B are cross-sectional views of the first coupling portion 132 and the second coupling portion 145a illustrated in FIG. 16. FIG. 22A illustrates an example of a structure in which the inner diameter of the first coupling portion 132 is larger than that of the second coupling portion 146a. FIG. 22B illustrates an example of a structure in which the inner diameter of the second coupling portion 146a is larger than that of the first coupling portion 132. The first coupling portion 132 is the same as that illustrated in FIG. 6.

As illustrated in FIGS. 22A and 22B, the second coupling portion 146a has a through hole 145-1 and a thin metal film 145-2 formed over the inner surface of the through hole 145-1. The through hole 145-1 penetrates the first layer 210, the insulating member 137, and the second layer 211. The second conductive portion 145a of the first layer 210 is electrically connected to the first conductive portion 131 of the second layer 211 via the thin metal film 145-2. The second coupling portion 146a can be formed by the same method as that for the first coupling portion 132. Although not illustrated in FIG. 12, the second coupling portions 146b to 146d each have the same structure as the second coupling portion 146a.

From the perspective of ease of manufacture, the inner diameter of the first coupling portion 132 may be the same as that of the second coupling portion 146a. Further, if it is desired to flow a large amount of electric current in order to increase the amount of heat (electric power) of the heat generation portion 130, the inner diameter of the first coupling portion 132 may be made larger than the inner diameter of the second coupling portion 146a as illustrated in FIG. 22A. Increase of the inner diameter of the first coupling portion 132 causes the area (surface area) of forming the thin metal film 145-2 to increase, resulting in decreased electric resistance of the first coupling portion 132, allowing the electric current to flow easily.

On the other hand, if the heat-equalizing effect is prioritized over the ease of the flow of electric current, the inner diameter of the second coupling portion 146a may be larger than that of the first coupling portion 132 as illustrated in FIG. 22B.

Additionally, both the first coupling portion 132 and the second coupling portion 146a are configured to penetrate the first layer 210, the insulating member 137, and the second layer 211. From the perspective of the mechanical strength of the heating member 114, it is preferable to use as small numbers of the first coupling portions 132 and the second coupling portions 146a as possible.

In addition, in order to make it easy to pattern the heat generation portion 130 and form terminals for power supply connection, the first coupling portion 132 is preferably disposed at an end portion of the heat generation portion 130.

### Size Relationship between Heat Generation Portion and First Conductive Portion

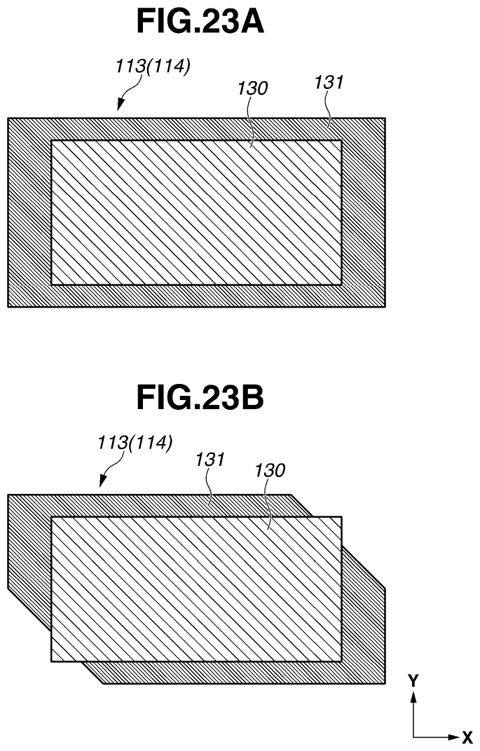

FIG. 23A and FIG. 23B are each a diagram for describing a relationship between the sizes of the heat generation portion 130 and the first conductive portion 131. FIG. 23A illustrates an example of the size relationship, and FIG. 23A illustrates another example of the size relationship.

As illustrated in FIG. 23A, in the heating member 113 (114), when the heat generation portion 130 and the first conductive portion 131 are projected in the thickness direction of the heating member 113 (114), the first conductive portion 131 includes the heat generation portion 130. According to this relationship, the temperature range ΔT₄ (ΔT₅) can be efficiently and effectively reduced.

As illustrated in FIG. 23B, in the heating member 113 (114), when the heat generation portion 130 and the first conductive portion 131 are projected in the thickness direction of the heating member 113 (114), the projected area of the first conductive portion 131 is larger than that of the heat generation portion 130. This relationship also makes it possible to efficiently and effectively reduce the temperature range ΔT₄ (ΔT₅).

### Arrangement (Order) of Layers of Heating Members with Respect to Flow Channel Member

In the heating members 113 and 114, the first conductive portion 131 is disposed opposite to the flow channel member 100 relative to the heat generation portion 130, but the exemplary embodiments of the present disclosure is not limited to that configuration. The first conductive portion 131 may be disposed closer to the flow channel member 100 than the heat generation portion 130.

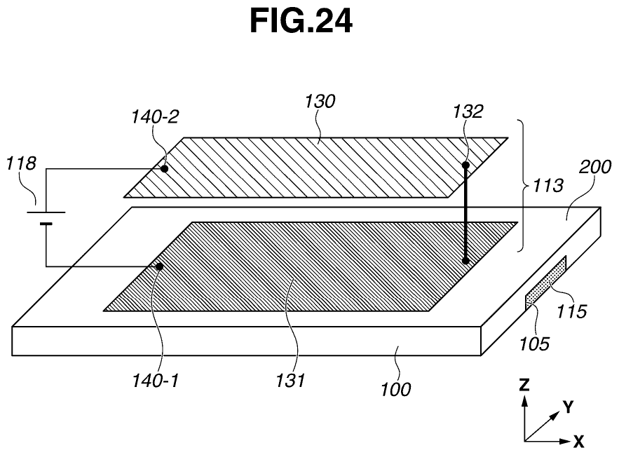

FIG. 24 is a schematic view illustrating a first modification of the liquid ejection head of the first exemplary embodiment. The first modification illustrated in FIG. 24 has basically the same configuration as the heating member 113 illustrated in FIG. 3 except that the first conductive portion 131 is disposed closer to the flow channel member 100 than the heat generation portion 130. The terminal 140-2 is disposed on the heat generation portion 130, and the terminal 140-1 is disposed on the first conductive portion 131.

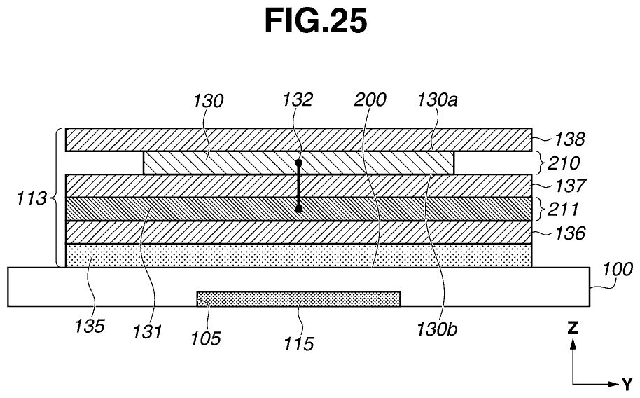

FIG. 25 is a cross-sectional view of the heating member 113 illustrated in FIG. 24. FIG. 25 illustrates a cross-sectional structure in which the first layer 210 including the heat generation portion 130 and the second layer 211 including the first conductive portion 131 in the cross-sectional structure illustrated in FIG. 4 are replaced with each other. The first conductive portion 131 is fixed to the outer wall surface 200 of the flow channel member 100 via the adhesive member 135 and the insulating member 136. The first conductive portion 131 faces the second surface 130b of the heat generation portion 130. Heat generated on the second surface 130b of the heat generation portion 130 is transmitted to the flow channel member 100 via the first conductive portion 131. The first conductive portion 131 acts to even out heat generated on the second surface 130b of the heat generation portion 130.

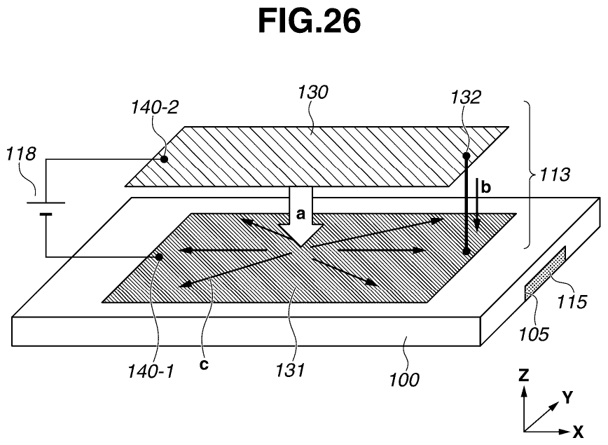

FIG. 26 is a schematic diagram illustrating heat conduction path of the heating member 113 illustrated in FIG. 24. In FIG. 26, the white arrow a and the solid arrows b and c indicate travel of heat.

Heat generated on the heat generation portion 130 travels from both the first surface 130a and the second surface 130b. Heat from the second surface 130b travels to the first conductive portion 131 via the insulating member 137 (the white arrow a) and via the first coupling portion 132 (the solid arrow b). Here, the temperature of the second surface 130b is highest at its center portion, and the white arrow a indicates the heat travel at the center portion. In the first conductive portion 131, heat from the central portion of the second surface 130b diffuses in in-plane directions (the solid arrows c). In this way, the first conductive portion 131 acts to even out heat generated on the second surface 130b of the heat generation portion 130.

The heat equalized by the first conductive portion 131 travels to the flow channel member 100 via the insulating member 136 and the adhesive member 135. Such heat conduction also makes it possible to effectively heat the liquid 115.

According to the exemplary embodiments of the present disclosure, even with increased amount of heat (electric power) of the heating member, liquid in a flow channel can be effectively heated.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-090691, filed Jun. 4, 2024, which is hereby incorporated by reference herein in its entirety.

What is claimed is:

1. A liquid ejection head comprising:
a flow channel member including a flow channel through which liquid flows; and
a heating member that is attached to an outer wall surface of the flow channel member and configured to heat the liquid in the flow channel,
the heating member including
a first layer including a heat generation portion configured to generate heat by applied power;
a second layer including a first conductive portion facing one surface of the heat generation portion; and
a first coupling portion that electrically couples the heat generation portion and the first conductive portion.

2. The liquid ejection head according to claim 1,
wherein the first layer includes a second conductive portion adjacent to the heat generation portion and electrically insulated from the heat generation portion, and
wherein the first layer includes a second coupling portion that electrically couples the first conductive portion and the second conductive portion.

3. The liquid ejection head according to claim 2, wherein the second conductive portion is disposed surrounding a peripheral edge portion of the heat generation portion.

4. The liquid ejection head according to claim 2, wherein the second conductive portion is disposed along both edge portions of the heat generation portion, the edge portions facing each other in a longer direction.

5. The liquid ejection head according to claim 2, wherein the second conductive portion is disposed along both edge portions of the heat generation portion, the edge portions facing each other in a shorter direction.

6. The liquid ejection head according to claim 2, wherein the second conductive portion is made of the same material as a material of the heat generation portion.

7. The liquid ejection head according to claim 2, wherein each of the first coupling portion and the second coupling portion has a structure in which a thin metal film is formed on an inner surface of a through hole penetrating the first layer and the second layer, and an inner diameter of the through hole of the first coupling portion is larger than an inner diameter of the through hole of the second coupling portion.

8. The liquid ejection head according to claim 2, wherein each of the first coupling portion and the second coupling portion has a structure in which a thin metal film is formed on an inner surface of a through hole penetrating the first layer and the second layer, and an inner diameter of the through hole of the second coupling portion is larger than an inner diameter of the through hole of the first coupling portion.

9. The liquid ejection head according to claim 1, wherein the first coupling portion is disposed at an end portion of the heat generation portion.

10. The liquid ejection head according to claim 1, wherein one of a pair of terminals for the applied power is disposed on the heat generation portion, and the other of the pair of terminals is disposed on the first conductive portion.

11. The liquid ejection head according to claim 1, wherein a pair of terminals for the applied power is disposed on the first layer.

12. The liquid ejection head according to claim 11, wherein the heat generation portion includes a first divided heat generation portion and a second divided heat generation portion that are electrically insulated from each other, and
wherein the first coupling portion includes a first division coupling portion and a second division coupling portion, the first division coupling portion electrically couples the first divided heat generation portion and the first conductive portion, the second division coupling portion electrically couples the second divided heat generation portion and the first conductive portion, and one of the pair of terminals is disposed on the first divided heat generation portion and the other of the pair of terminals is disposed on the second divided heat generation portion.

13. The liquid ejection head according to claim 1, wherein a pair of terminals for the applied power is disposed on the second layer.

14. The liquid ejection head according to claim 13, wherein the first conductive portion includes a first divided conductive portion and a second divided conductive portion that are electrically insulated from each other,
wherein the first coupling portion includes a first division coupling portion and a second division coupling portion, the first division coupling portion electrically couples the first divided conductive portion and the heat generation portion, the second division coupling portion electrically couples the second divided conductive portion and the heat generation portion, and one of the pair of terminals is disposed on the first divided conductive portion and the other of the pair of terminals is disposed on the second divided conductive portion.

15. The liquid ejection head according to claim 1, wherein the first conductive portion covers the heat generation portion in a case where the heat generation portion and the first conductive portion are each projected in a thickness direction of the heating member.

16. The liquid ejection head according to claim 1, wherein in a case where the heat generation portion and the first conductive portion are each projected in a thickness direction of the heating member, a projected area of the first conductive portion is larger than a projected area of the heat generation portion.

17. The liquid ejection head according to claim 1, wherein the heating member is attached to the outer wall surface of the flow channel member such that the first layer is positioned between the flow channel member and the second layer.

18. The liquid ejection head according to claim 1, wherein the heating member is attached to the outer wall surface of the flow channel member such that the second layer is positioned between the flow channel member and the first layer.
